(19) United States
(12) Patent Application Publication
(10) Pub. No.: US 2007/0051751 A1
(43) Pub. Date: Mar. 8, 2007

(54) T-Post Gun Rack

(76) Inventor: Robert J. Mason, Hugoton, KS (US)

Correspondence Address: MARTIN S. HIGH, P.O. BOX 217, STILLWATER, OK, 74076, US

(21) Appl. No.: 11/530,037

(22) Filed: Sep. 8, 2006

Related U.S. Application Data
(60) Provisional application No. 60/715,274, filed on Sep. 8, 2005.

(51) Int. Cl. B67D 5/60

(52) U.S. Cl. 222/145.2

(57) ABSTRACT

The instant invention is comprised of a t-post receptacle and a gun support. The fence post receptacle is essentially a short cylinder comprised of an outside circumferential surface, an inside fence post receiving channel, a top surface, and a bottom surface. The gun support is affixed to the outside circumferential surface. The inside fence post receiving channel can be formed to accept all shapes of fence post including, but not limited to, circular and “T-post” fence posts. The inside fence post receiving channel is also comprised of a set screw that securely engages the inside fence post receiving channel to the fence post. The gun support is comprised of any compliant material that will not mark or damage a metal gun barrel including, but not limited to, natural rubber, synthetic rubber, soft polymeric material or polymer based foam.

### CROSS-REFERENCE TO RELATED APPLICATIONS (UNLESS INCLUDED IN THE APPLICATION DATA SHEET)

This application claims the benefit of U.S. Provisional Application No. 60/715,274 filed on Sep. 8, 2005 titled “T-Post Gun Rack.” The entire contents of provisional application 60/715,274 are herein incorporated by reference.

### STATEMENT REGARDING FEDERALLY SPONSORED RESEARCH OR DEVELOPMENT

Not Applicable

### REFERENCE TO A “SEQUENCE LISTING,” A TABLE, OR A COMPUTER PROGRAM LISTING

Not Applicable

### BACKGROUND OF THE INVENTION

1. Field of Invention

The instant invention involves the general area of supporting guns in the field. More specifically, the instant invention involves supporting guns on so called “t-posts.”

2. Description of Prior Art

T-posts are commonly used in rural areas to support wire and barbed wired fencing. A sportsman or group of sportsman commonly has a need to support guns where no gun support is present. T-posts can be easily placed in the ground in field conditions given an available t-post and a suitable device to drive a t-post into the ground. A device that can be used in conjunction with t-posts to support guns would provide a convenient method to safely support guns in the field.

In addition, it is difficult to find a location on which to support guns on fences supported by t-posts. The sportsman often wishes to rest the gun along some portion of the fence, but this can often prove dangerous and even fatal if the weapon is unexpectedly jarred from its position on the fence. Alternatively, the sportsman may place the gun on the ground, but this may damage the gun through contact with soil or moisture. Quite often a sportsman wishes to safely support a gun in the vicinity of a t-post fence with the further aim of crossing the fence line. Again, it is very difficult to safely cross the fence line without injuring the sportsman or damaging the gun. The sportsman is faced with the option of placing the gun directly on the ground which may damage the gun, or place the gun in some vertical position along the t-post fence. Again, this later approach can prove dangerous if the gun is inadvertently jarred from its location on the fence while the fence is traversed.

Therefore, the purpose of the instant invention is to provide a safe support for guns in the field using readily available t-posts.

### BRIEF SUMMARY OF THE INVENTION

The instant invention is comprised of a fence post receptacle and a gun support. The fence post receptacle is essentially a short cylinder comprised of an outside circumferential surface, an inside fence post receiving channel, a top surface, and a bottom surface. The gun support is affixed to the outside circumferential surface. The inside fence post receiving channel can be formed to accept all shapes of fence post including, but not limited to, circular and “T-post” fence posts. In one preferred embodiment of the instant invention, the inside fence post receiving channel, most readily seen in FIG. 3, is formed to accept the roughly “T” shape of a t-post. The inside fence post receiving channel is also comprised of a set screw that securely engages the inside fence post receiving channel to the t-post. The fence post receptacle is manufactured from aluminum or a polymeric material. If a polymeric material is used, a small amount of an ultraviolet light inhibitor is included in the polymeric material to extend the useful life of the gun support.

The gun support is comprised of any compliant material that will not mark or damage a metal gun barrel including, but not limited to, natural rubber, synthetic rubber, soft polymeric material or polymer based foam.

The use of the instant invention is relatively simple: the user slides the instant invention over the top of a t-post engaging the t-post into the t-post receptacle. The user then fastens the instant invention securely to the t-post by tightening the set screws. In one preferred embodiment of the t-post gun rack, the set screw is a winged screw so that the user of the t-post gun rack can tighten the set screw by hand without the aid of tools. In a best mode of use the gun being supported is long gun or rifle.

In another preferred embodiment of the invention, the t-post receptacle is shaped so that it can accommodate fence posts with shapes other than a “t-post” including, but not limited to square fence posts, triangular fence posts, and circular fence posts.

The instant invention may also be used to support other long, cylindrical objects including, but not limited to, piping, reinforcing bars, fishing poles, and golf clubs. The instant invention can be used to support other objects that are long and capable of being supported such as archery equipment. The instant invention may also be used as a ready-to-go gun rack in the field. For example, when sportsman need a temporary gun storage location a t-post can be installed in the ground, a t-post gun support installed, and the guns stored on the gun support.

The instant invention can be particularly useful in the circumstances that sporting clay enthusiasts typically find themselves. When a sporting clay enthusiast wishes to shoot clay targets, he or she usually finds a large open field. Unfortunately, this scenario does not readily have a means to support the weapons. Using the instant invention in conjunction with a t-post solves this dilemma for the sporting clay enthusiast.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be used as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### BRIEF DESCRIPTION OF THE SEVERAL VIEWS OF THE DRAWINGS

FIG. 1 shows a top perspective view of the t-post gun rack.

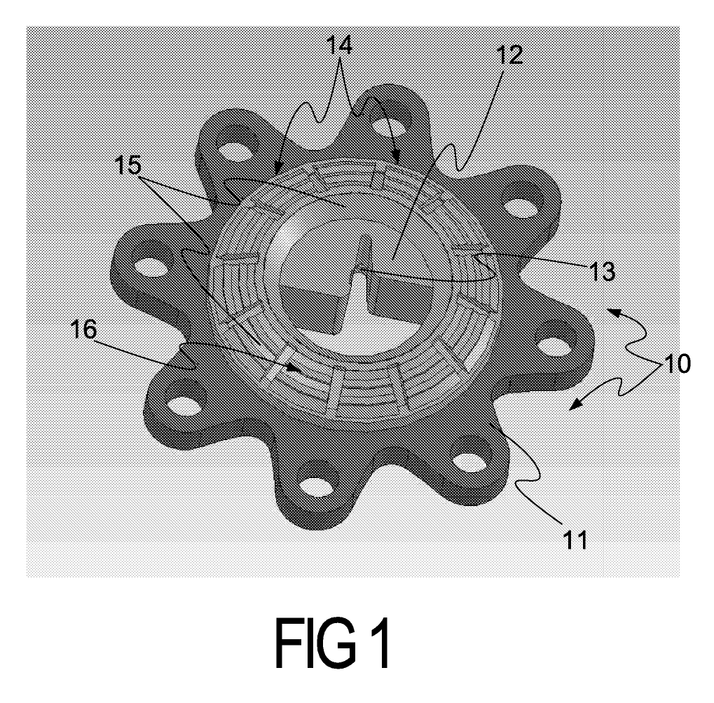

FIG. 2 shows a bottom perspective view of the t-post gun rack.

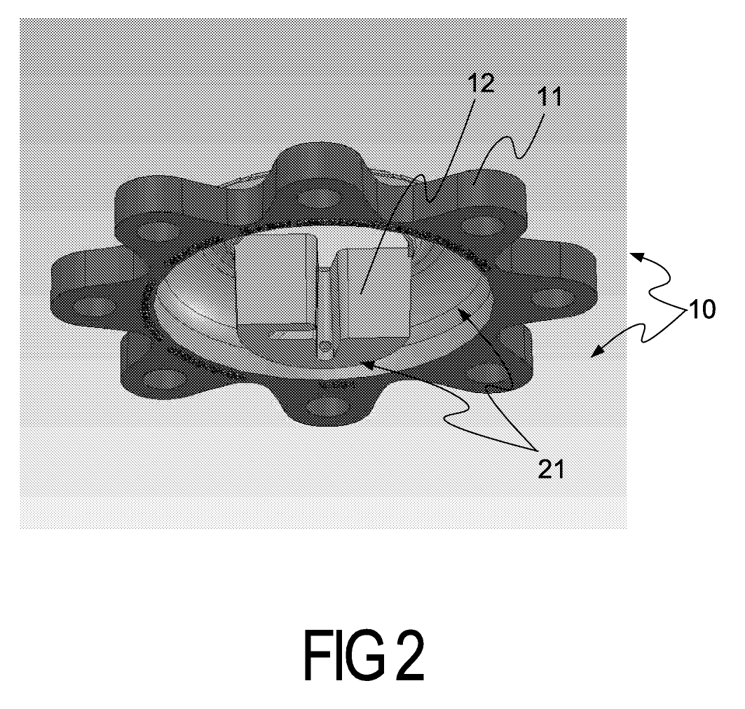

FIG. 3 shows a top view of the t-post gun rack.

FIG. 4 shows a side view of the t-post gun rack.

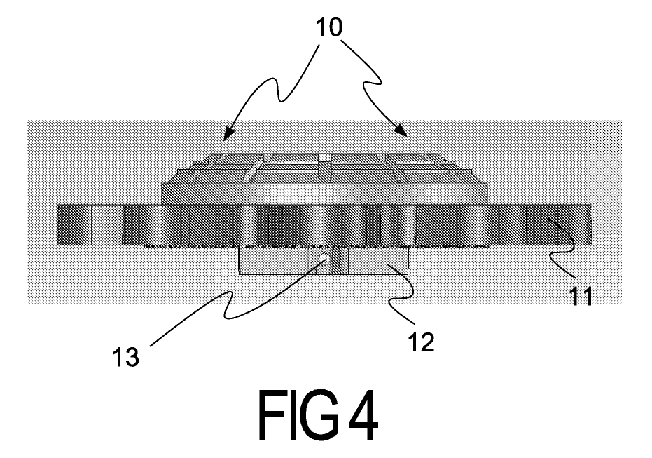

FIG. 5 shows a perspective view of the t-post gun rack installed on a t-post

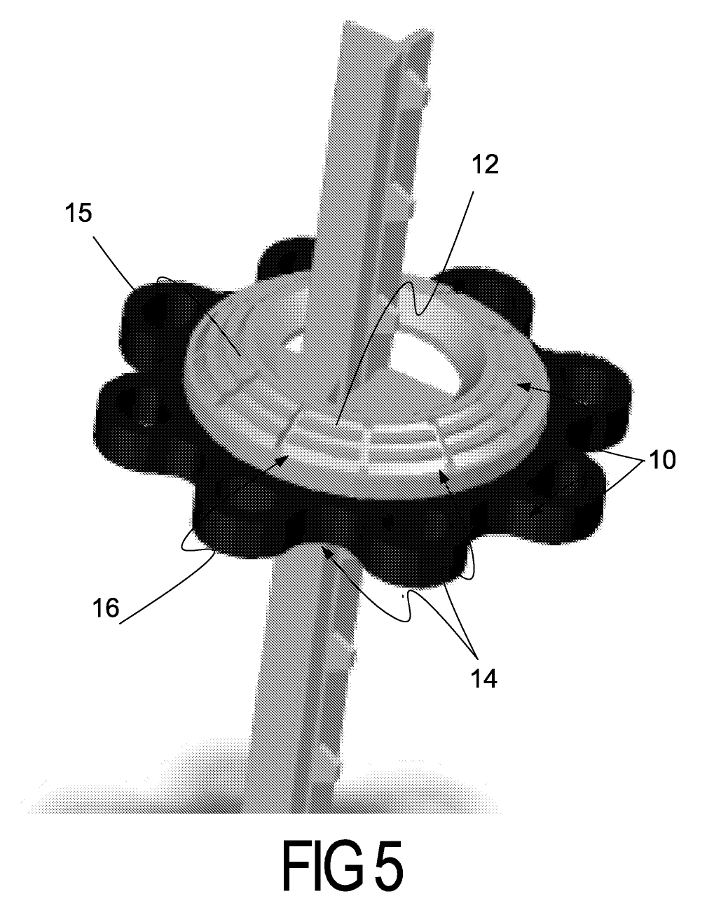

### DETAILED DESCRIPTION OF THE INVENTION

The instant invention 10 is comprised of a fence post receptacle 15 and a gun support 11. The fence post receptacle 15 is essentially a short cylinder comprised of an outside circumferential surface 14, an inside fence post receiving channel 12, a top surface 16, and a bottom surface 21. The gun support 11 is affixed to the outside circumferential surface 14.

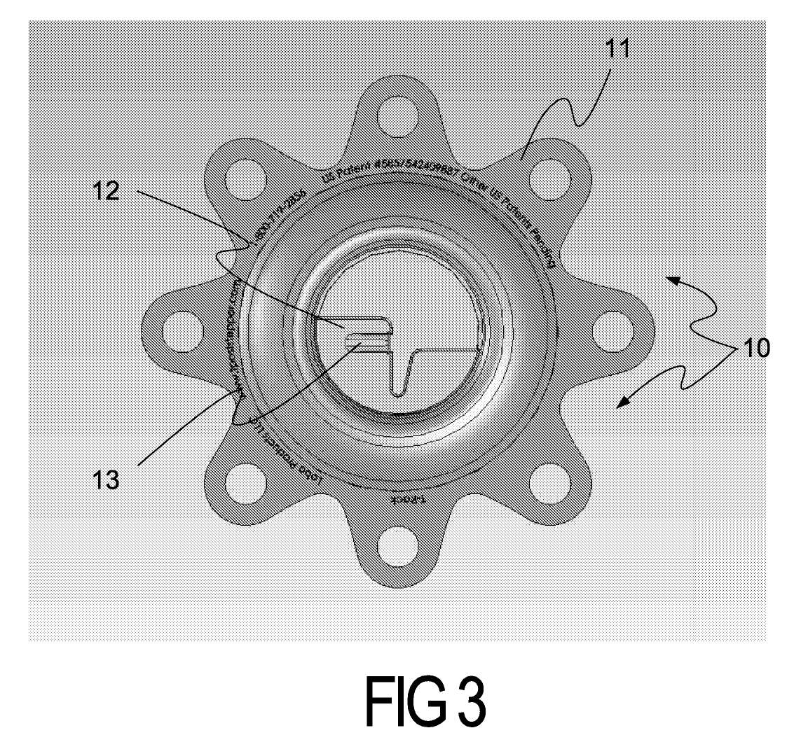

In one preferred embodiment of the invention, the fence post receiving channel is formed to receive a fence post with a circular cross section. In another preferred embodiment of the invention, the fence post receiving channel 12, most readily seen in FIG. 3, is formed to accept the roughly “T” shape of a t-post. Other preferred embodiments of the instant invention allow for receipt of other shapes of fence posts.

The fence post receiving channel 12 is also comprised of a set screw 13 that passes through the fence receptacle 15 and securely engages the fence post receiving channel against the fence post. In one preferred embodiment of the fence post gun rack, the set screw 13 is a winged screw so that the user of the fence post gun rack can tighten the set screw by hand without the aid of tools.

The fence post receptacle is manufactured from metallic or a polymeric material. If a metallic material is aluminum or steel is commonly employed, but other metals may be used. If a polymeric material is used, a small amount of an ultraviolet light inhibitor is included in the polymeric material to extend the useful life of the gun support. The gun support is comprised of any compliant material that will not mark or damage a metal gun barrel including, but not limited to, natural rubber, synthetic rubber, soft polymeric material or polymer based foam.

It should be emphasized that the instant invention is versatile in that in another preferred embodiments, the fence post receptacle is shaped so that it can accommodate fence posts with shapes other than a “t-post” including, but not limited to square fence posts, triangular fence posts, and circular fence posts. The inside fence post receiving channel can be formed to accept all shapes of fence post including, but not limited to, circular and “T-post” fence posts.

The use of the instant invention is relatively simple: the user slides the instant invention over the top of a t-post engaging the t-post into the t-post receptacle. The user then fastens the instant invention securely to the fence post by tightening the set screws. The user then supports his rifle or shotgun against the instant invention simply by putting the butt of the weapon on the ground, and placing the barrel of the weapon against the gun support.

The instant invention may also be used to support other long, cylindrical objects including, but not limited to, piping, reinforcing bars, fishing poles, and golf clubs. A long cylindrical object is to be construed broadly as any object greater than 3 feet in length and with a average diameter along its length of less than 3 inches. The instant invention can be used to support other objects that are long and capable of being supported such as archery equipment. The instant invention may also be used as a ready-to-go gun rack in the field. For example, when sportsman need a temporary gun storage location a t-post can be installed in the ground, a t-post gun support installed, and the guns stored on the gun support.

The instant invention can be particularly useful in the circumstances that sporting clay enthusiasts typically find themselves. When a sporting clay enthusiast wishes to shoot clay targets, he or she usually finds a large open field. Unfortunately, this scenario does not readily have a means to support the weapons. Using the instant invention in conjunction with a t-post solves this dilemma for the sporting clay enthusiast.

What is claimed is:

1. A gun support comprising
a fence post receptacle; and
a gun support.

2. A gun support as described in claim 1 where
the fence post receptacle is essentially a short cylinder comprised of
an outside circumferential surface,
an inside fence post receiving channel,
a top surface, and
a bottom surface.

3. A gun support as described in claim 1 where
the fence post receptacle is manufactured from metallic or polymeric materials.

4. A gun support as described in claim 1 where
the fence post receptacle is manufactured from aluminum and the gun support is manufactured from polymeric foam.

5. A gun support as described in claim 1 where
the fence post receptacle is manufactured from aluminum and the gun support is manufactured from natural or synthetic rubber.

6. A method to support guns comprising
inserting a t-post into the ground;
installing a t-post gun support onto the t-post;
placing the weapon to be supported against t-post gun support.

7. A method to support a long cylindrical object comprising
inserting a t-post into the ground;
installing a t-post gun support onto the t-post;
placing the long cylindrical object to be supported against t-post gun support.
